(19) United States
(12) Patent Application Publication
(10) Pub. No.: US 2026/0161194 A1
(43) Pub. Date: Jun. 11, 2026

(54) CURVED DISPLAY DEVICE

(71) Applicants: Fuzhou BOE Optoelectronics Technology Co., Ltd., Fuzhou, Fujian (CN); BOE Technology Group Co., Ltd., Beijing (CN)

(72) Inventors: Lian FANG, Beijing (CN); Han ZHANG, Beijing (CN); Hongyu ZHAO, Beijing (CN); Liangliang REN, Beijing (CN); Ming CHEN, Beijing (CN); Yuhang LIN, Beijing (CN); Hui YU, Beijing (CN); Chengkun LIU, Beijing (CN); Long HU, Beijing (CN); Ting CUI, Beijing (CN); Zhiying CHEN, Beijing (CN); Kai DIAO, Beijing (CN); Qingen ZHOU, Beijing (CN); Dingjie ZHENG, Beijing (CN); Zhijie GUO, Beijing (CN); Tianfeng ZHANG, Beijing (CN)

(21) Appl. No.: 18/705,606

(22) PCT Filed: Apr. 23, 2023
(86) PCT No.: PCT/CN2023/090123

§ 371 Date: Apr. 29, 2024

(30) Foreign Application Priority Data
Apr. 24, 2022 (CN) 202220957401.6

(51) Int. Cl. G06F 1/16; G02F 1/1333; G02F 1/13357; G06F 1/18; G06F 1/184; G06F 1/188

(52) U.S. Cl. CPC G06F 1/1601; G06F 1/182; G06F 1/184; G06F 1/188; G06F 1/189; G02F 1/133305; G02F 1/133603; G06F 2200/1612

(57) ABSTRACT

A curved display apparatus, includes a display panel, a backlight module, and a rear housing. The display panel and the rear housing are arranged opposite to each other in a first direction. The display panel includes a display area and a non-display area. The non-display area includes a connection portion, a first control portion, and a second control portion. The connection portion is located on the side of the first control portion away from the display area, and the second control portion is located on the side of the connection portion away from the display area. The connection portion is bendable such that the second control portion is folded to the side of the backlight module facing away from the display panel and is opposite to the first control portion, and the second control portion is connected to the backlight module.

### CROSS-REFERENCE TO RELATED APPLICATIONS

The present application is a U.S. National Phase Entry of International Application PCT/CN2023/090123 having an international filing date of Apr. 23, 2023, which claims priority to Chinese Patent Application No. 202220957401.6 filed to the CNIPA on Apr. 24, 2022 and entitled “CURVED DISPLAY DEVICE”, and the contents disclosed in the above-mentioned applications are hereby incorporated as a part of this application.

### TECHNICAL FIELD

Embodiments of the present disclosure relate, but are not limited, to the field of display technologies, and in particular to a curved display apparatus.

### BACKGROUND

At present, the curvature of curved display apparatuses is increasingly great, and the thickness of display panels of the curved display apparatuses is increasingly thinner, which lead to an increasing probability of crack display panels in an assembly process of the curved display apparatuses, resulting in low machining efficiency and low yield of the curved display apparatuses.

### SUMMARY

The following is a summary of subject matters described herein in detail. This summary is not intended to limit the protection scope of claims.

A curved display apparatus is provided in an embodiment of the present disclosure, which includes: a display panel, a backlight module and a rear housing, wherein the display panel and the rear housing are disposed opposite to each other in a first direction, the backlight module is disposed between the rear housing and the display panel, the display panel includes a display area and a non-display area including a connection portion, a first control portion and a second control portion, the connection portion is on a side of the first control portion away from the display area, the second control portion is on a side of the connection portion away from the display area, the connection portion can be bent such that the second control portion is folded to a side of the backlight module away from the display panel, so as to be disposed opposite to the first control portion in the first direction, and the second control portion is connected with the backlight module, wherein the rear housing includes a first housing and a second housing which are separate components, and the second housing is disposed opposite to at least part of the second control portion located on the side of the backlight module away from the display panel.

According to the curved display apparatus in the embodiment of the present disclosure, by providing the first housing and the second housing as separate components, the assembly sequence of the first housing and the second housing can be adaptively adjusted according to the relevant requirements of the curved display apparatus, such as protecting the display panel. For example, the first housing is installed at first, then the display panel is installed, and the second housing is installed finally, so as to simplify the assembly process of the curved display apparatus after installing the display panel, effectively avoid crack of the display panel, and improve the machining efficiency and the yield of the curved display apparatus.

In some embodiments, the second housing and the first housing are detachably connected.

In some embodiments, the second control portion is detachably connected with the backlight module.

In some embodiments, the second housing is fitted with the first housing through a lip

In some embodiments, the first housing is located on an upper side of the second housing, a female lip is formed at a lower end of the first housing, a male lip is formed at an upper end of the second housing, and the male lip is fitted to an inner side of the female lip.

In some embodiments, the curved display apparatus further includes a main board module which is disposed between the backlight module and the rear housing, and includes a control main board, a power supply board and a shielding component, wherein both of the control main board and the power supply board are disposed in the shielding component, and the shielding component is fixedly connected with the backlight module.

In some embodiments, the backlight module includes a backplate to which the shielding component is fixedly connected.

In some embodiments, the curved display apparatus further includes a connector located on a side of the second control portion away from the backlight module, and the connector is detachably connected with the backlight module.

In some embodiments, the curved display apparatus further includes a wire organizer formed with an organizing space for accommodating wires of the curved display apparatus, and the wire organizer is integrated with the second housing.

In some embodiments, the curved display apparatus further includes a bracket adapter fixedly connected with the backlight module, the first housing is formed with standard VESA holes, the bracket adapter is formed with a first connection hole, and a fastener is penetrated through the standard VESA holes and the first connection hole to fixedly connect the bracket adapter with the first housing.

In some embodiments, the curved display apparatus further includes a main board module including a control main board, a power supply board and a shielding component, wherein the power supply board is disposed outside the rear housing, the control main board is disposed in the shielding component, the shielding component is disposed between the backlight module and the rear housing, and is fixedly connected with the backlight module, the shielding component and the bracket adapter are integrated.

In some embodiments, the curved display apparatus further includes a support frame provided with a second connection hole, the fastener is penetrated through the second connection hole, the standard VESA holes and the first connection hole to fixedly connect the support frame, the first housing and the bracket adapter, and a quick disassembly structure is provided between the support frame and the bracket adapter.

In some embodiments, the curved display apparatus further includes a quick disassembly structure, the quick disassembly structure includes a snap joint which is fixedly disposed on the bracket adapter and movable between a locked position and an unlocked position along a second direction, the snap joint is snap-fitted on the support frame in the locked position, the snap joint is separated from the support frame in the unlocked position, and the second direction is perpendicular to the first direction.

In some embodiments, the quick disassembly structure further includes an unlocking member movably disposed on the bracket adapter along the first direction, and the unlocking member is pressed to move the snap joint towards the unlocked position.

In some embodiments, the quick disassembly structure further includes a reset member used to push the snap joint to move towards the locked position.

Other aspects of the present disclosure may be comprehended after the drawings and the detailed descriptions are read and understood.

### BRIEF DESCRIPTION OF DRAWINGS

The above mentioned and/or additional aspects and advantages of the present disclosure will become apparent and easy to understand from following description of embodiments in conjunction with accompanying drawings.

FIG. 1 is a schematic diagram of a curved display apparatus in an embodiment of the present disclosure.

FIG. 2 is another schematic diagram of the curved display apparatus shown in FIG. 1.

FIG. 3 is an enlarged view of a part A circled in FIG. 2.

FIG. 4 is an exploded diagram of a curved display apparatus according to an embodiment of the present disclosure.

FIG. 5 is an enlarged view of a part B circled in FIG. 4.

FIG. 6 is an exploded diagram of a quick disassembly structure shown in FIG. 5.

FIG. 7 is another exploded diagram of the curved display apparatus shown in FIG. 1.

FIG. 8 is yet another exploded diagram of the curved display apparatus shown in FIG. 7 in which a connection portion is not bent.

FIG. 9 is another yet exploded diagram of the curved display apparatus shown in FIG. 8 in which the connection portion has been bent.

FIG. 10 is a cross-sectional view of the curved display apparatus shown in FIG. 7.

FIG. 11 is an enlarged view of a portion C circled in FIG. 10.

FIG. 12 is a schematic diagram of a display panel shown in FIG. 8 in which the connection portion is not bent.

### DETAILED DESCRIPTION

The present disclosure is described in detail below, and examples of the embodiments are illustrated in the drawings, in which the same or similar reference signs always denote the same or similar components or components having the same or similar functions. The embodiments described below with reference to the accompanying drawings are illustrative, and are merely intended to explain the present disclosure, which cannot be interpreted as a limitation on the present disclosure.

In the following, many different embodiments or examples are provided for implementing different structures of the present disclosure. In order to simplify the present disclosure, components and arrangements of specific examples are described below. Of course, they are examples only and are not intended to limit the present disclosure. In addition, reference numbers and/or letters may be repeated between different examples in the present disclosure. Such repetition is for purposes of simplicity and clarity, and does not in itself indicate a relationship between each of the embodiments and/or arrangements discussed. In addition, examples of various specific processes and materials are provided in the present disclosure, but those of ordinary skilled in the art will be aware of applicability of other processes and/or usages of other materials.

The embodiments and features in the embodiments of the present disclosure may be randomly combined with each other if there is no conflict.

Hereinafter a curved display apparatus 100 according to an embodiment of the present disclosure is described with reference to the accompany drawings.

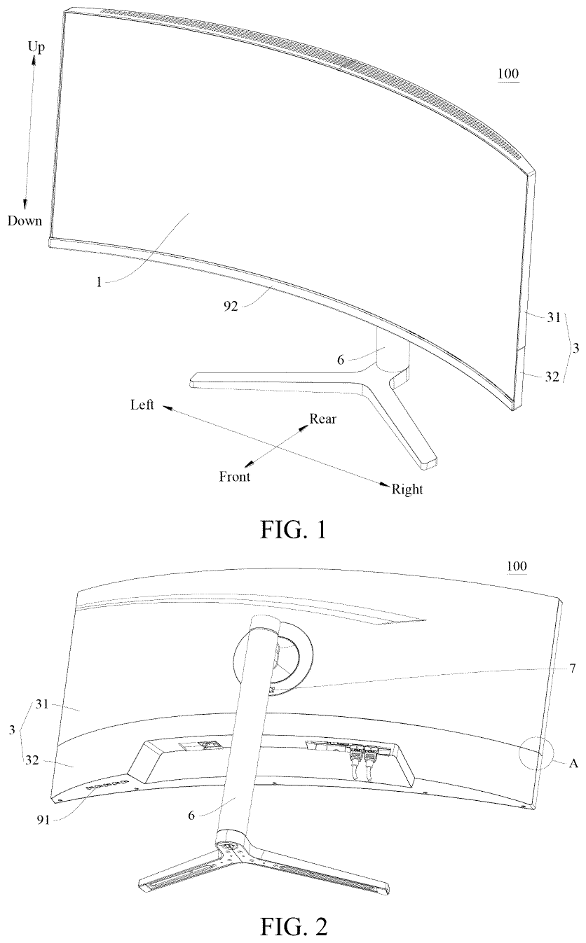

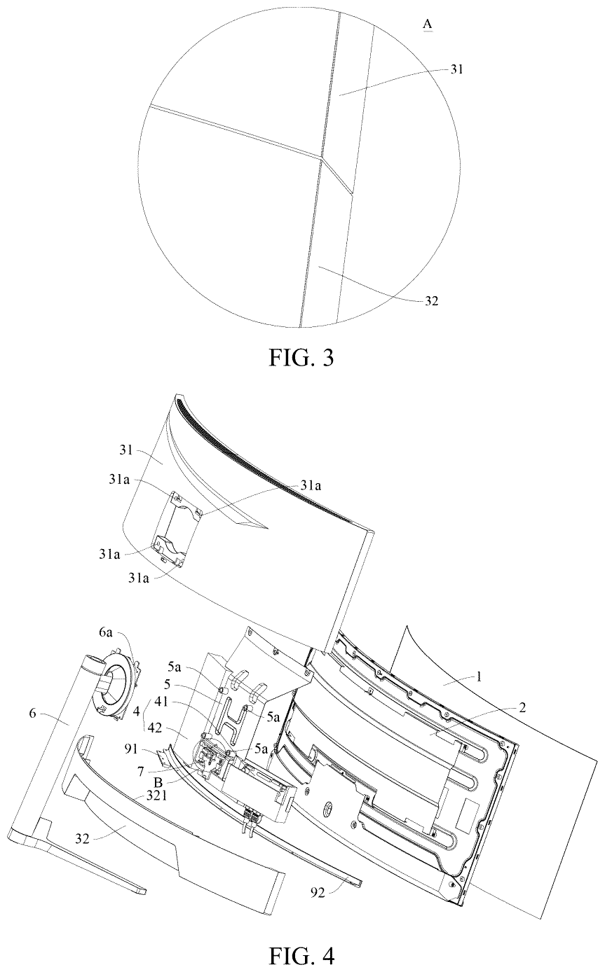

As shown in FIGS. 1 to 4, 8 and 12, the curved display apparatus 100 includes a display panel 1, a backlight module 2 and a rear housing 3, wherein the display panel 1 and the rear housing 3 are disposed opposite to each other in a first direction (i.e., a front-rear direction in the figure), the backlight module 2 is disposed between the rear housing 3 and the display panel 1, and the backlight module 2 can provide a light source for the display panel 1. The display panel 1 includes a display area 11 and a non-display area 12. The curved display apparatus 100 can display text, images and other information through the display area 11. The non-display area 12 includes a connection portion 121, a first control portion 122 and a second control portion 123, wherein the connection portion 121 is located on a side of the first control portion 122 away from the display area 11, and the second control portion 123 is located on a side of the connection portion 121 away from the display area 11. The connection portion 121 can be bent such that the second control portion 123 is folded to a side of the backlight module 2 away from the display panel 1. At that time, the second control portion 123 and the first control portion 122 are disposed opposite to each other in the first direction, and the second control portion 123 is connected to the backlight module 2. For example, in the example in FIG. 12, the first control portion 122 is disposed around the display area 11, the connection portion 121, which may be a Flexible Printed Circuit (FPC), is located radially outside the first control portion 122.

The second control portion 123 is folded to the side of the backlight module 2 away from the display panel 1 by the connection portion 121, so as to reduce a flat space occupied by the non-display area 12, increase a screen-to-body ratio of the curved display apparatus 100, and improve display effect, thereby improving user experience.

As shown in FIGS. 2, 4, 8 and 9, the rear housing 3 includes a first housing 31 and a second housing 32 which are separate components, wherein the second housing 32 is disposed opposite to at least part of the second control portion 123 located on the side of the backlight module 2 away from the display panel 1. That is, the first housing 31 and the second housing 32 are separately machined, and then the first housing 31 and the second housing 32 are respectively assembled in turn. In other words, an assembly sequence of the first housing 31 and the second housing 32 can be adaptively adjusted according to relevant requirements of the curved display apparatus 100, such as protecting the display panel 1, etc., so as to effectively prevent the display panel 1 from being broken during assembling the curved display apparatus 100 For example, the backlight module 2 is assembled at first, and corresponding components (such as the bracket adapter 5, the shielding component, etc. described later) are mounted on the backlight module 2, then the first housing 31 is mounted, and then the display panel 1 is mounted, and finally the second housing 32 is mounted.

Compared with some technologies in which after a display panel and a backlight module are assembled, it is necessary to turn the display panel and the backlight module upside down on a jig for a subsequent assembly process, connect lines and finally assemble a rear housing of the curved display apparatus, resulting in the display panel being easy to crack in the subsequent assembly process; in the embodiment of the present disclosure, providing the first housing 31 and the second housing 32 as separate components is convenient to reasonably arrange a sequential assembly sequence of the first housing 31, the second housing 32 and the display panel 1. For example, the first housing 31 may be installed at first, then the display panel 1 may be installed, and finally the second housing 32 may be installed. That is, on the premise of ensuring reliable installation of the display panel 1, after the display panel 1 is installed, the assembly process of the curved display apparatus 100 in the present disclosure is simple, which is beneficial to avoiding crack of the display panel 1, improving a machining efficiency and a yield of the curved display apparatus 100, and effectively reducing a rework rate of the curved display apparatus 100.

According to the mounting process of the display panel 1 in the embodiment of the present disclosure, the connection portion 121 is bent such that the second control portion 123 is folded to the side of the backlight module 2 away from the display panel 1 so as to be opposite to the first control portion 122 in a first direction, and after the second control portion 123 is connected with the backlight module 2, mounting of the display panel 1 is accomplished.

For example, the display area 11 has a plurality of edges sequentially connected end to end, and the connection portion 121, the first control portion 122 and the second control portion 123 are located at one of the edges of the display area 11. The following is illustrated by taking that a first direction is the front-rear direction as shown in FIG. 1, the display area 11 is in a shape of square, and the connection portion 121, the first control portion 122, and the second control portion 123 are located on a lower side of the display area 11 as an example. After reading the following technical scheme, those skilled in the art can easily understand other technical schemes. In the example shown in FIGS. 1, 8, 9 and 12, both the backlight module 2 and the rear housing 3 are located on a back side of the display panel 1, and the rear housing 3 is located on a back side of the backlight module 2. Before the connection portion 121 is bent, all of the connection portion 121, the first control portion 122 and the second control portion 123 are located at the lower side of the display area 11, the first housing 31 is located at on an upper side of the second housing 32. After the connection portion 121 is bent, the second control portion 123 is folded to the back side of the backlight module 2, the first control portion 122 is still located at a front side of the backlight module 2, the connection portion 121 is located at a lower side of the backlight module 2, and is disposed corresponding to a lower edge of the backlight module 2. For example, before the connection portion 121 is bent, all of the connection portion 121, the first control portion 122, and the second control portion 123 are located on a left side of the display area 11, and the second housing 32 is located on a left side of the first housing 31, which is not limited thereto. For example, before the connection portion 121 is bent, all of the connection portion 121, the first control portion 122, and the second control portion 123 are located on an upper side of the display area 11, and the second housing 32 is located on an upper side of the first housing 31, which is not limited thereto.

There is no restriction on a mating mode and a connection method between the first housing 31 and the second housing 32.

According to the curved display apparatus 100 in the embodiment of the present disclosure, the display panel 1 is in a curved structure, and the backlight module 2 may be in a curved structure. For example, both the display panel 1 and the backlight module 2 are formed into a cylindrical structure, and both of the display panel 1 and the backlight module 2 have a certain degree of curvature, so that the curved display apparatus 100 has a certain degree of curvature.

According to the curved display apparatus 100 in the embodiment of the present disclosure, by providing the first housing 31 and the second housing 32 as separate components, the assembly sequence of the first housing 31 and the second housing 32 can be adaptively adjusted according to the relevant requirements of the curved display apparatus 100, such as protecting the display panel 1. For example, the first housing 31 is installed at first, then the display panel 1 is installed, and the second housing 32 is installed finally, so as to simplify the assembly process of the curved display apparatus 100 after installing the display panel 1, effectively avoid crack of the display panel 1, and improve the machining efficiency and the yield of the curved display apparatus 100.

The embodiment of the present disclosure can be used to solve a problem that the display panel 1 is easy to break in the assembly process of the curved display apparatus 100, especially for the curved display apparatus 100 with large curvature. The embodiment of the present disclosure can improve the assembly efficiency and the yield of the curved display apparatus 100 with large curvature.

Alternatively, the display panel 1 is a liquid crystal display panel (also known as an Open Cell (OC for short)). For example, the liquid crystal display panel includes a first substrate, a second substrate, and a liquid crystal layer disposed between the first substrate and the second substrate, wherein the first substrate and the second substrate are disposed opposite to each other along a thickness direction of the liquid crystal display panel. The backlight module 2 may be an LED backlight module, and the LED may be one of a Mini Light Emitting Diode (Mini LED for short) and a Micro Light Emitting Diode (Micro LED for short).

In the description of the embodiments of the present disclosure, the direction “front side” may be construed as a side of the curved display apparatus 100 facing a user when the curved display apparatus 100 is in use, and a side of the curved display apparatus 100 away from the user may be construed as the “back side”. For example, in the examples of FIGS. 1 and 4, the first direction may be the front-rear direction, the display panel 1 is disposed on a front side of the rear housing 3, and the backlight module 2 is disposed between the rear housing 3 and the display panel 1.

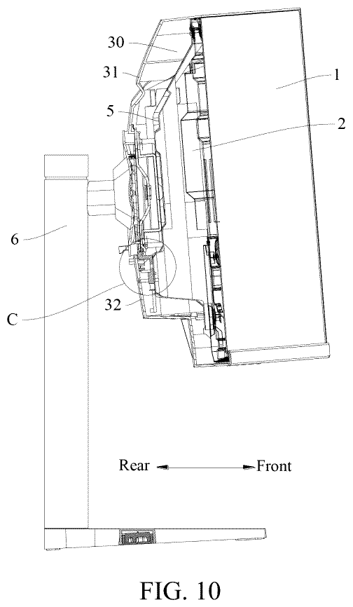

In some embodiments, as shown in FIG. 10, the rear housing 3 defines an accommodation space 30 for accommodating the backlight module 2, and the rear housing 3 may protect the backlight module 2 to some extent.

In some embodiments of the present disclosure, the second housing 32 is detachably connected with the first housing 31, so that the second housing 32 can be detached after the curved display apparatus 100 is assembled. Since the second housing 32 is opposite to at least part of the second control portion 123 located on the side of the backlight module 2 away from the display panel 1, at least part of the second control portion 123 located on the side of the backlight module 2 away from the display panel 1 is exposed, so as to facilitate maintenance of the display panel 1. For example, the second control portion 123 is detachably connected with the backlight module 2 such that the second control portion 123 can be detached from the backlight module 2 when the display panel 1 needs to be replaced, so as to facilitate detachment of entire display panel 1 for replacement. When the display panel 1 is damaged during use of the curved display apparatus 100, the above-mentioned solution facilitates rework, simplify a rework process, thereby reducing a maintenance operation cost.

In an embodiment of the present disclosure, a detachable connection method between the second housing 32 and the second housing 32 is not restricted, as long as it ensures that the second housing 32 can be detached from the first housing 31. Similarly, a detachable connection method between the second control portion 123 and the backlight module 2 is not restricted, as long as it ensures that the second control portion 123 can be detached from the backlight module 2.

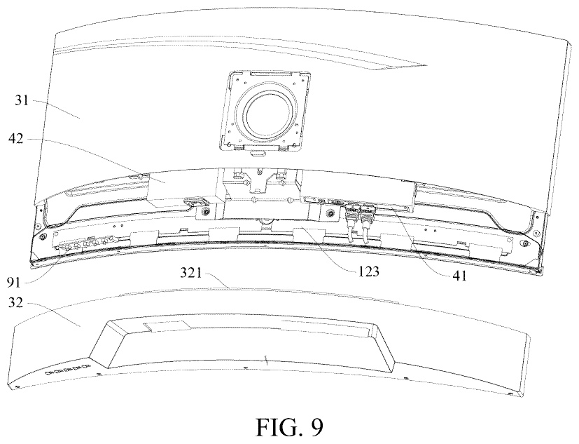

Optionally, in an example in FIGS. 8 and 9, the curved display apparatus 100 further includes a connector which is disposed on a side of the second control portion 123 away from the backlight module 2, and is detachably connected with the backlight module 2 (for example, a backplate of the backlight module 2) to achieve fixing of the second control portion 123, and the connector can cover at least part of the second control portion 123 to protect the second control portion 123 to some extent. For example, the connector may be a Printed Circuit Board (PCB) cover.

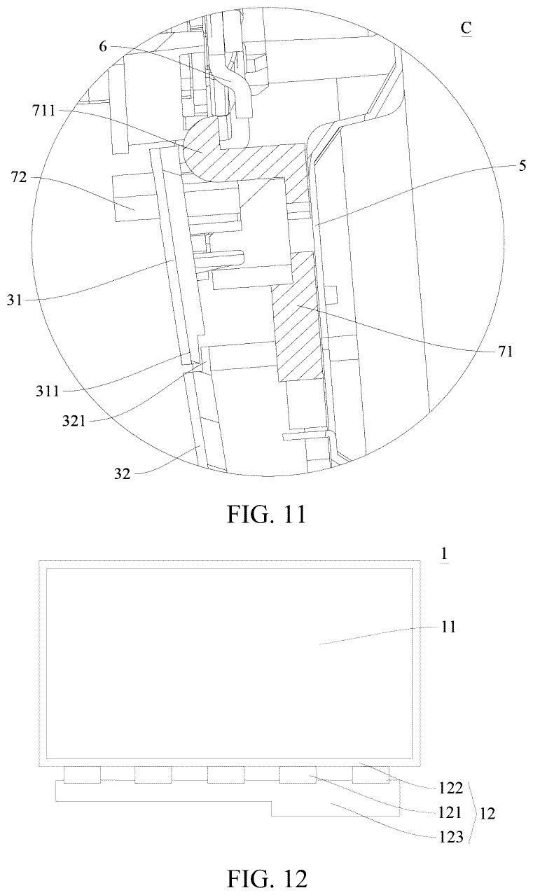

In some embodiments of the present disclosure, as shown in FIGS. 10 and 11, the second housing 32 fits, through a lip, with the first housing 31 to avoid misalignment, breakage and the like when the first housing 31 and the second housing 32 are assembled, which is beneficial to ensuring an assembly accuracy between the first housing 31 and the second housing 32, reducing relative deformation between the first housing 31 and the second housing 32, controlling a gap between the first housing 31 and the second housing 32, controlling the assembly sequence of the first housing 31 and the second housing 32, and is convenient to modify the gap between the first housing 31 and the second housing 32. That is, the lip fitting of the second housing 32 with the first housing 31 can modify and control the gap and a step between the first housing 31 and the second housing 32.

Optionally, a type of the lip between the second housing 32 and the first housing 31 may include at least one of a true lip, a false lip, a semi-false lip, a double lip and the like. For example, in the example shown in FIGS. 10 and 11, the first housing 31 is located on the upper side of the second housing 32, a female lip 311 is formed at a lower end of the first housing 31, a male lip 321 is formed at an upper end of the second housing 32, and the male lip 321 is fitted to an inner side of the female lip 311, so that the lip fitting structure between the first housing 31 and the second housing 32 is simple and convenient for machining. In addition, the second housing 32 is detachable, so as to ensure an assembly accuracy of the second housing 32 when the second housing 32 is reassembled.

For example, a length of the female lip 311 may be less than or equal to a length of the first housing 31, and a length of the male lip 321 may be less than or equal to a length of the second housing 32.

Furthermore, the type of the lip between the second housing 32 and the first housing 31 can be adjusted according to a shape of the curved display apparatus 100, and the like. That is, the type of the lip between the second housing 32 and the first housing 31 can be adjusted according to different Industrial Designs (IDs) and the like.

Of course, the first housing 31 and the second housing 32 may be fitted in other methods, which is not limited to the lips.

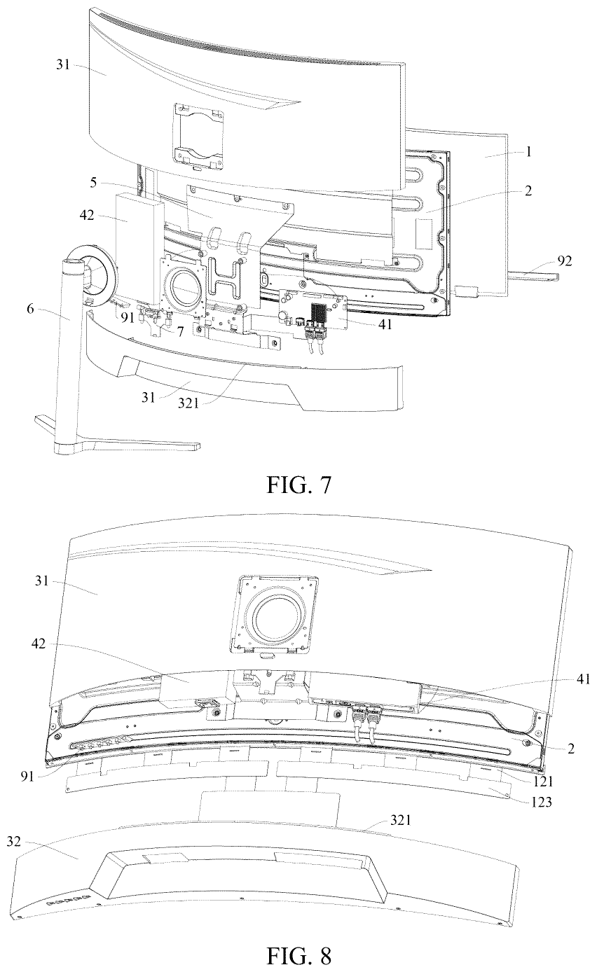

In some embodiments of the present disclosure, as shown in FIGS. 4, 7 to 9, the curved display apparatus 100 further includes a main board module 4, wherein the main board module 4 is disposed between the backlight module 2 and the rear housing 3, and the main board module 4 includes a control main board 41, a power supply board 42 and a shielding component. Both of the control main board 41 and the power supply board 42 are disposed in the shielding component, so that the shielding component can reduce an interference of electromagnetic waves in the external environment to a normal operation of the control main board 41 and the power supply board 42, and improve display quality, display stability and service life of the curved display apparatus 100. Furthermore, the shielding component can attenuate electromagnetic waves emitted by the curved display apparatus 100, reducing an intensity of electromagnetic radiation emitted by the curved display apparatus 100, and reducing damage of the curved display apparatus 100 to users and the environment.

The shielding component is fixedly connected with the backlight module 2, so as to reliably install the shielding component. For example, the backlight module 2 includes a backplate with which the shielding component is fixedly connected.

When the curved display apparatus 100 is in use, if there are more electromagnetic radiation sources beside the curved display apparatus 100, these electromagnetic radiation sources continuously emit electromagnetic waves to interfere with the normal operation of the curved display apparatus 100, which may cause the curved display apparatus 100 to experience image jitter or even produce color spots, and in severe cases, may lead to image disorder.

In some embodiments of the present disclosure, the curved display apparatus 100 further includes a wire organizer formed with an organizing space for accommodating wires of the curved display apparatus 100, so that the wire organizer can organize and accommodate the wires of the curved display apparatus 100 (e.g., a signal line, a power line and the like of the curved display apparatus 100), which facilitates improving the tidiness of, and convenience for use of the curved display apparatus 100.

The wire organizer can be integrated with the second housing 32, which is beneficial to improving integrity of the curved display apparatus 100, reducing a quantity of molds (e.g. plastic molds) needed for machining the curved display apparatus 100, thereby reducing the cost. Optionally, the wire organizer is integrally injection-molded with the second housing 32. A position of the wire organizer may be set according to practical applications.

In some embodiments of the present disclosure, as shown in FIGS. 4, 7 and 11, the curved display apparatus 100 further includes a bracket adapter 5 fixedly connected with the backlight module 2, and the bracket adapter 5 is fixedly connected with the first housing 31, so that the bracket adapter 5 can apply supporting force to the backlight module 2 and the first housing 31, respectively. Therefore, the curved display apparatus 100 can be stably installed by directly or indirectly stabilizing the bracket adapter 5. For example, the curved display apparatus 100 can be placed on a horizontal plane or mounted on a wall. The first housing 31 is formed with standard VESA (i.e. Video Electronics Standards Association) holes 31a to facilitate standard VESA mounting of the curved display apparatus 100, for example, to facilitate wall mounting of the curved display apparatus 100. The bracket adapter 5 is formed with first connection holes 5a, and a fastener is penetrated through the standard VESA holes 31a and the first connection holes 5a to fixedly connect the bracket adapter 5 with the first housing 31. Thus, the bracket adapter 5 can be fixed while the curved display apparatus 100 is mounted, which is convenient to simplify a mounting process of the curved display apparatus 100.

Of course, the standard VESA holes 31a in the first housing 31 can also achieve horizontal placement of the curved display apparatus 100. For example, a support frame 6 described below is provided, so that the support frame 6 is fixed to the first housing 31 by the standard VESA holes 31a, and the support frame 6 is fixed to the bracket adapter 5 by the first connection holes 5a, so that the support frame 6 is stably placed on a horizontal plane, thus achieving horizontal placement of the curved display apparatus 100.

A structure and arrangement of the standard VESA holes 31a are well known to those skilled in the art, which will not be repeated herein.

In some embodiments, the curved display apparatus 100 further includes a main board module 4 that includes a control main board 41, a power supply board 42 and a shielding component. The power supply board 42 is disposed outside the rear housing 3, which is beneficial to improving the convenience of setting the power supply board 42, and is convenient to provide more space for setting other components inside the rear housing 3, or is beneficial to reducing a volume of the rear housing 3 and saving space occupied by the rear housing 3. The control main board 41 is disposed in the shielding component, and the shielding component is provided between the backlight module 2 and the rear housing 3, so that the shielding component can reduce the interference of electromagnetic waves and the like in the external environment to a normal operation of the control circuit and the like on the control main board 41, improve the display quality, display stability and service life of the curved display apparatus 100, attenuate the electromagnetic waves emitted by the curved display apparatus 100, reduce the intensity of electromagnetic radiation emitted by the curved display apparatus 100, and reduce damage of the curved display apparatus 100 to users and the environment.

The shielding component and the backlight module 2 are fixedly connected, so as to achieve reliable installation of the shielding component, and the shielding component and the bracket adapter 5 are integrated, which effectively improves an installation stability of the shielding component, reduces a quantity of molds needed for machining the curved display apparatus 100, is beneficial to reducing the cost, saving processes of assembling the shielding component with the bracket adapter 5, and does not need a connection structure on the shielding component or the bracket adapter 5, which is beneficial to simplifying structures of the shielding component and the bracket adapter 5.

In some embodiments, as shown in FIG. 4, the curved display apparatus 100 further includes a support frame 6 formed with a second connection hole 6a, and a fastener is penetrated through the second connection hole 6a, the standard VESA holes 31a and the first connection holes 5a to fixedly connect the support frame 6, the first housing 31 and the bracket adapter 5, then the support frame 6, the first housing 31 and the bracket adapter 5 are connected into a whole, so as to achieve the stable support of the support frame 6 to the backlight module 2 and the display panel 1, achieve stable and reliable installation of the curved display apparatus 100, and further improve the assembly efficiency of the curved display apparatus 100.

It can be understood that the support frame 6 may be placed on a horizontal plane or may be mounted on a wall.

As shown in FIGS. 4 to 6, a quick disassembly structure 7 is provided between the support frame 6 and the bracket adapter 5, so as to achieve quick disassembly of the support frame 6 and the bracket adapter 5, thereby improving a disassembly efficiency of the curved display apparatus 100, thereby improving maintenance convenience of the curved display apparatus 100.

In an embodiment of the present disclosure, a structure of the quick disassembly structure 7 between the support frame 6 and the bracket adapter 5 may be configured according to actual applications, as long as it ensures that the quick disassembly of the support frame 6 and the bracket adapter 5 can be achieved.

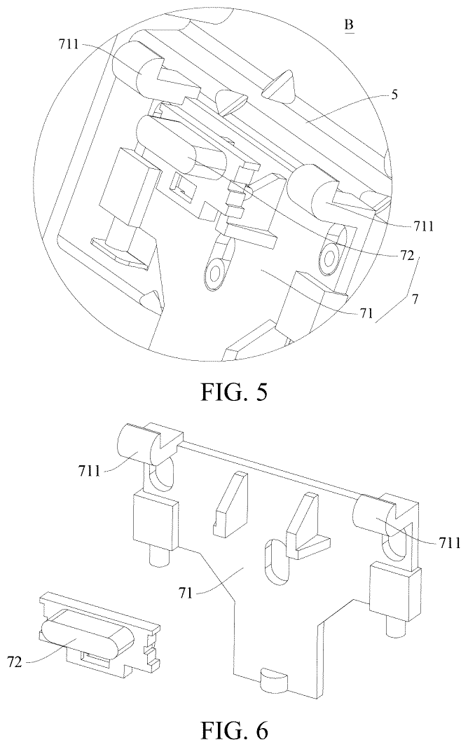

In some alternative embodiments, as shown in FIGS. 5, 6 and 11, the quick disassembly structure 7 includes a snap joint 71 fixed to the bracket adapter 5 and movable in a second direction between a locked position and an unlocked position, then the snap joint 71 and the bracket adapter 5 slide fitting in the second direction, wherein the second direction is perpendicular to the first direction. In the locked position, the snap joint 71 is snap-fitted on the support frame 6, so that the support frame 6 and the bracket adapter 5 are fixed by the snap joint 71, which is convenient to reliably fix the bracket adapter 5 to the support frame 6. In the unlocked position, the snap joint 71 is separated from the support frame 6, so as to achieve separation of the bracket adapter 5 from the support frame 6.

It can be understood that the second direction may be any direction perpendicular to the first direction; when the first direction is the front-rear direction, the second direction may be a vertical direction, a horizontal direction, or the like. For example, in the example in FIGS. 5, 6, and 11, the first direction is the front-rear direction, the second direction is the vertical direction, the locked position may be above the unlocked position, and in the locked position, a hook 711 of the snap joint 71 may be hooked on a rear side of the support frame 6.

As shown in FIGS. 5, 6, and 11, the quick disassembly structure 7 further includes an unlocking member 72 movably provided on the bracket adapter 5 along a first direction, and the unlocking member 72 is pressed to push the snap joint 71 to move in a direction towards the unlocked position, wherein the pressing direction is parallel to the first direction. Thus, the user can unlock the quick disassembly structure 7 by pressing the unlocking member 72, thereby further improving the convenience of separating the support frame 6 from the bracket adapter 5.

The quick disassembly structure 7 further provides a reset member, which is used to push the snap joint 71 to move towards the locked position, and then the reset member applies a force moving towards the locked position to the snap joint 71, so that the snap joint 71 has a moving trend towards the locked position, which is convenient to reset the snap joint 71 to the locked position after moving to the unlocked position, and is convenient to ensure that the snap joint 71 is stable in the locked position, so as to ensure stable connection of the support frame 6 with the bracket adapter 5.

For example, the reset member is an elastic member which applies an elastic force to the snap joint 71 to move the snap joint 71 towards the locked position. When the snap joint 71 is in the unlocked position, the elastic member may be in a compressed state, and the elastic member applies an elastic force to the snap joint 71 to move the snap joint 71 towards the locked position. Of course, when the snap joint 71 is in the unlocked position, the elastic member may also be in a stretched state, and the elastic member may also apply an elastic force to the snap joint 71 to move the snap joint 71 towards the locked position. Therefore, it is convenient to simplify a structure of the reset member and reduce the cost.

The following is illustrated by taking the front-rear direction as the first direction, the vertical direction as the second direction, and the elastic member being in the compressed state in the unlocked position as an example. After reading the following technical scheme, those skilled in the art can easily understand other technical schemes. In the example in FIGS. 5, 6 and 11, the locked position may be located above the unlocked position, and the unlocking member 72 is pressed forward to push the snap joint 71 to move down to the unlocked position against a force of the elastic member, so as to achieve separation of the support frame 6 from the bracket adapter 5, releasing the unlocking member 72, and the snap joint 71 is reset to the locked position under an action of the elastic member, and the unlocking member 72 can also be reset under an actuation of the snap joint 71.

For example, an assembly process of the curved display apparatus 100 includes: assembling the backlight module 2 at first, and then assembling an entire curved display apparatus 100, that is, fixing both the control main board 41 and the power supply board 42 in the shielding component, and mounting the shielding component on the backlight module 2, and then mounting the bracket adapter 5 and the corresponding wires, and mounting the first housing 31; then mounting the display panel 1, a screen connecting wire of the curved display apparatus 100, and a connector for fixing the second control portion 123; finally mounting the second housing 32, an operation key 91 of the curved display apparatus 100 and a key wire for the operation key 91, and a decorative strip 92.

Other configurations and operations of the curved display apparatus 100 according to the embodiments of the present disclosure are known to those of ordinary skilled in the art, which will not be described in detail herein.

In the description of the present disclosure, it should be understood that, orientation or position relationships indicated by terms “center”, “longitudinal”, “transverse”, “length”, “width”, “thickness”, “upper”, “lower”, “front”, “back”, “left”, “right”, “vertical”, “horizontal”, “top”, “bottom”, “inside”, “outside”, “clockwise”, “counterclockwise”, “axial”, “radial”, “circumferential” and the like are based on the orientation or position relationships shown in the drawings, and are only for the convenience of description of the embodiments of the present disclosure and simplification of the description, but are not intended to indicate or imply that the mentioned device or element must have a specific orientation, or be constructed and operated in a particular orientation, and therefore they should not be construed as limitations on the present disclosure. Furthermore, features defined by “first” and “second” may explicitly or implicitly include one or more such features. In the description of the present disclosure, “plurality/multiple” means two or more than two, unless otherwise specified.

In the description of the present disclosure, it should be noted that unless otherwise specified and limited, the terms “mount”, “connected” and “connect” should be understood in a broad sense. For example, a connection may be fixed connection, detachable connection or integrated connection, may be mechanical connection or electrical connection, or may be direct connection, indirect connection through intermediate medium, or communication in two elements. Those of ordinary skills in the art may understand meanings of these terms in the embodiments of the present disclosure with reference to specific situations.

In the above description, the description with reference to the terms “an embodiment”, “some embodiments”, “exemplary embodiment”, “exemplary embodiment”, or “some examples” or the like means that the features, structures, materials, or characteristics described in conjunction with the embodiments or examples are included in at least one embodiment or example of the present disclosure. In this description, the exemplary description of the above terms is not necessarily directed to the same embodiment or example. Moreover, described features, structures, materials, or characteristics may be combined in any one or more embodiments or examples in a suitable manner.

Although embodiments of the present disclosure have been illustrated and described, those of ordinary skilled in the art may understand that multiple changes, modifications, substitutions, and variations may be made to these embodiments without departing from principles and purposes of the present disclosure. The scope of the present disclosure is defined by the claims and their equivalents.

1. A curved display apparatus, comprising: a display panel, a backlight module and a rear housing, wherein the display panel and the rear housing are disposed opposite to each other in a first direction, the backlight module is disposed between the rear housing and the display panel, the display panel comprises a display area and a non-display area comprising a connection portion, a first control portion and a second control portion, the connection portion is located on a side of the first control portion away from the display area, the second control portion is located on a side of the connection portion away from the display area, the connection portion is bendable such that the second control portion is folded to a side of the backlight module away from the display panel, so as to be disposed opposite to the first control portion in the first direction, and the second control portion is connected with the backlight module,
wherein the rear housing comprises a first housing and a second housing which are separate components, and the second housing is disposed opposite to at least part of the second control portion located on the side of the backlight module away from the display panel.

2. The curved display apparatus of claim 1, wherein the second housing is detachably connected with the first housing.

3. The curved display apparatus of claim 2, wherein the second control portion is detachably connected with the backlight module.

4. The curved display apparatus of claim 1, wherein the second housing is fitted with the first housing through a lip.

5. The curved display apparatus of claim 4, wherein the first housing is located on an upper side of the second housing, a female lip is formed at a lower end of the first housing, a male lip is formed at an upper end of the second housing, and the male lip is fitted to an inner side of the female lip.

6. The curved display apparatus of claim 1, further comprising:
a main board module which is disposed between the backlight module and the rear housing, and comprises a control main board, a power supply board and a shielding component, wherein both of the control main board and the power supply board are disposed in the shielding component, and the shielding component is fixedly connected with the backlight module.

7. The curved display apparatus of claim 6, wherein the backlight module comprises a backplate, and the shielding component is fixedly connected to the backplate.

8. The curved display apparatus of claim 1, further comprising:
a connector located on a side of the second control portion away from the backlight module, and the connector being detachably connected with the backlight module.

9. The curved display apparatus of claim 1, further comprising:
a wire organizer formed with an organizing space for accommodating wires of the curved display apparatus, and the wire organizer being integrated with the second housing.

10. The curved display apparatus of claim 1, further comprising:
a bracket adapter fixedly connected with the backlight module, the first housing being formed with standard VESA holes, the bracket adapter being formed with a first connection hole, and a fastener being penetrated through the standard VESA holes and the first connection hole to fixedly connect the bracket adapter with the first housing.

11. The curved display apparatus of claim 10, further comprising:
a main board module comprising a control main board, a power supply board and a shielding component, wherein the power supply board is disposed outside the rear housing, the control main board is disposed in the shielding component, the shielding component is disposed between the backlight module and the rear housing, and is fixedly connected with the backlight module, the shielding component and the bracket adapter are integrated.

12. The curved display apparatus of claim 10, further comprising:
a support frame provided with a second connection hole, the fastener being penetrated through the second connection hole, the standard VESA holes and the first connection hole to fixedly connect the support frame, the first housing and the bracket adapter, and a quick disassembly structure being provided between the support frame and the bracket adapter.

13. The curved display apparatus of claim 12, wherein the quick disassembly structure comprises:
a snap joint which is fixedly disposed on the bracket adapter and movable between a locked position and an unlocked position along a second direction, the snap joint is snap-fitted on the support frame in the locked position, the snap joint is separated from the support frame in the unlocked position, and the second direction is perpendicular to the first direction.

14. The curved display apparatus of claim 13, wherein the quick disassembly structure further comprises an unlocking member movably disposed on the bracket adapter along the first direction, and the unlocking member is pressed to push the snap joint towards the unlocked position.

15. The curved display apparatus of claim 13, the quick disassembly structure further comprises:
a reset member used to push the snap joint to move towards the locked position.
